(19) United States
(12) Patent Application Publication
(10) Pub. No.: US 2011/0047873 A1
(43) Pub. Date: Mar. 3, 2011

(54) MULTIPLE DOOR PET ACCESS SYSTEM

(76) Inventors: JEFF KUHN, Modesto, CA (US); Janis Kuhn, Modesto, CA (US)

(21) Appl. No.: 12/939,633

(22) Filed: Nov. 4, 2010

Related U.S. Application Data
(63) Continuation of application No. 12/387,495, filed on May 4, 2009, now abandoned.

(51) Int. Cl. E06B 3/32; E05F 1/00; G08B 21/18

(52) U.S. Cl. 49/13; 49/168

(57) ABSTRACT

A pet access door apparatus for an associated building includes a frame; a first opening defined by the frame having a first size; a second opening defined by the frame having a second size that is different from the first size. The openings each have a flap disposed therein, each a flap has an edge. The edge engages the frame whereby the flap is suspended from the edge. Each flap has first and second sides. The apparatus further includes discrete first retractable stops abutting a first side of each of the flaps, each first retractable stop retracts to allow movement of the abutting flap in a first direction and extends to prevent movement of the abutting flap in the first direction; the apparatus further includes discrete second stops abutting a second side of each of the flaps, each second stop retracts to allow movement of the second flap in a second direction and extends to prevent movement of the second flap in the second direction. The apparatus further includes a microcontroller and each of the first stops and the second stops are controlled by the microcontroller. This embodiment may be programmable to individually limit opening of each of the flaps in addition to being programmable with respect to the time and duration of retraction and extension of each stop.

### RELATED APPLICATIONS

This application is a continuation of provisional application Ser. No. 61/215,280 filed on 05/0412009 by Jeff E. Kuhn as well as non provisional patent application Ser. No. 12/387,495 also filed on May 4, 2009 Jeff E. Kuhn and Janis Kuhn.

### FIELD OF THE INVENTION

The invention has particular application to methods and apparatus for allowing entrance and exit of pets from a building and particularly to methods and apparatus for allowing and limiting the entrance and exit of multiple pets. For example, the invention has application to homeowners who own both a large dog and a small dog or who own both a house cat and a larger dog.

### BACKGROUND OF THE INVENTION

The prior art includes a wide variety of pet doors. At http://www.moorepet-petdoors.com/?Click=1016&gclid=CMjphf69gp8CFQHxDAodlCCipw various pet doors are described including pet doors for a range of door thickness; single and dual flapped insulating pet doors; pet doors designed for installation into walls that have either already made tunnels or with tunnel kits available; pet doors that regulate access of pets and also doors that are designed to keep out intruders; inserts for sliding glass doors; lightweight utility models as well as dual paned, dual flapped insulated embodiments; cat doors that are manual to electronic and infrared models; window pet doors for sash and side sliding windows; Pet doors designed for installation into window screens, sliding screen doors and porch screens; pet doors custom made to fit the glass panes of true french doors; custom made window inserts specially made to fit your side sliding window; pet doors for installation into thin or insulated storm doors; pet doors used for installation into overhead garage doors; as well as pet doors that work perfectly for all types or porches from screened to Lanais;

### SUMMARY OF THE INVENTION

While the prior art is useful for wide variety of applications, it does not address certain issues unique to the owners of several pets and particularly if the pets are of different sizes. In a surprisingly large number of instances individual pet owners many own a cat and a larger dog or a small dog and a larger dog. More particularly, the known prior art does not enable the owner of the respective pets to predetermine the times at which each of the respective pets may enter or exit a building such as a residential building or other premises.

It is an object of the present invention to provide apparatus that includes discrete passageways or openings for respectively a smaller and a larger pet.

Another object of the present invention is to provide apparatus that enables the pet owner to predetermine respective times after which each of their respective pets may enter a given premises.

A further object of the present invention is to provide apparatus that enables the pet owner to predetermine respective times after which each of the respective pets may exit a given premises.

Still another object of the present invention is to provide apparatus that enables the pet owner to predetermine a window in time during which each of their respective pets mate enter a given premises.

Yet another object of the present invention is to provide apparatus that enables the pet owner to predetermine a window in time during which each of their respective pets mate exit a given premises.

A further object of the present invention is to maximize energy conservation by preventing loss of air that has been heated or cooled by the building's heating, ventilation and air conditioning system.

Yet another object of the present invention is to assist pet owners of limited mobility who may be challenged to repetitively physically open and close a door to allow pets in and out of the premises.

A still further object of the present invention is to minimize the occurrence of pets having “accidents” inside the home.

It has now been found that these and other objects to the present invention may be attained in all or some of the embodiments of the present invention a pet access door apparatus for an associated building which includes a frame; a first opening defined by the frame having a first size; and a second opening defined by the frame having a second size that is different from the first size.

In some embodiments each of the openings has a flap disposed therein, each a flap has an edge, the edge engaging the frame whereby the flap is suspended from the edge. Each flap may include peripheral magnetic material at peripheral portions thereof remote from the edge whereby the flap is releasably magnetically latched to the frame when the flap is suspended from the frame at the edge. In embodiments of the present invention wherein the frame is aluminum, the flap may be magnetically latched by means of a ferromagnetic pad in combination with a permanent magnet. Some embodiments include a structure wherein each flap has first and second sides and the apparatus further includes a first retractable stop abutting a first side of at least one of the flaps. The first retractable stop may retract to allow movement of the at least one of the flaps in a first direction. Similarly, the first retractable stop may extend to prevent movement of the at least one of the flaps in a first direction.

The apparatus may further including a second stop abutting a second side of at least one of the flaps. The second stop may retract to allow movement of the flaps in a second direction. Similarly, the second stop may extend to prevent movement of the flap in a second direction. The apparatus may further including a microcontroller and one or more of the stops may be controlled by the microcontroller. The apparatus may further include an alarm if either flap remains open for more than a predetermined time. The apparatus is programmable to individually limit opening of each flap in some embodiments. The apparatus is programmable with respect to the time and duration of retraction and extension of each stop in some embodiments.

One embodiment of the pet access door apparatus for an associated building includes a frame; a first opening defined by the frame having a first size; a second opening defined by the frame having a second size that is different from the first size. The openings each having a flap disposed therein, each a flap has an edge, the edge engages the frame whereby the flap is suspended from the edge; each flap has first and second sides. The apparatus further includes discrete first retractable stops abutting a first side of each of the flaps, each first retractable stop retracts to allow movement of the abutting flap in a first direction and extends to prevent movement of the abutting flap in the first direction. The apparatus further includes discrete second stops abutting a second side of each of the flaps, each second stop retracts to allow movement of the abutting flap in a second direction and extends to prevent movement of the abutting flap in the second direction. The apparatus further includes a microcontroller and each of the first stop and the second stops are controlled by the microcontroller. This embodiment may be programmable to individually limit opening of each of the flaps in addition to being programmable with respect to the time and duration of retraction and extension of each stop.

### BRIEF DESCRIPTION OF THE DRAWING

The invention will be better understood by reference to the accompanying drawing in which:

FIG. 1 is a perspective view of one embodiment of the present apparatus providing respective openings for each of the respective pets.

FIG. 2 is a diagrammatic view illustrating a magnetic latch for securing respective flaps to the frame

FIG. 3 is a diagrammatic view representing a microcontroller an apparatus for constraining movement of a flap door with respect to either the opening or closing of such a door as well as both the opening and closing of such a door. This to a diagrammatic representation will be understood to be applicable to each of the two discrete openings illustrated in FIG. 1.

### DESCRIPTION OF THE PREFERRED EMBODIMENTS

The present invention provides access for entry and exit of respective relatively large and relatively small pets with respect to a given premises. Some embodiments may be constructed merely to allow entry of one or both pets with the intent that the owner will allow the pad to exit through a more conventional door in utilize the present apparatus only to allow return of the pet into the premises. The apparatus of the present invention may be installed in a variety of doors, including, but not limited to, a sliding glass door. The door in accordance with in the present invention may be customized to accommodate intended animal use as well have the nature of the door or other building structure such as the wall of the building. The present invention is additionally intended to maximize energy conservation by preventing loss of air heated or cooled that has been condition by the building's heating, ventilation and air conditioning. The pet door in accordance with the present invention is additionally useful for pet owners of limited mobility as they will not need to continually physically open and close a door to allow pets in and out of the premises.

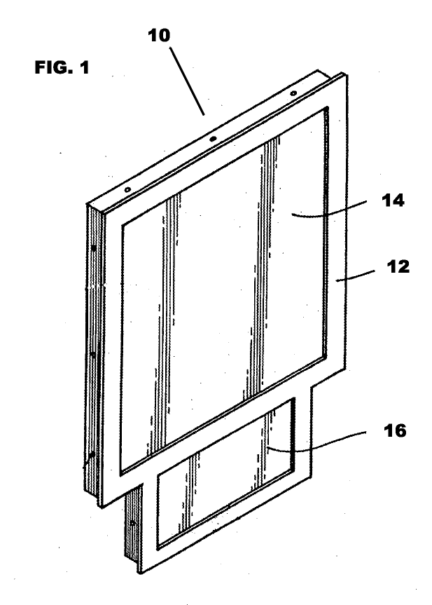

Referring now to FIG. 1 there is shown a preferred embodiment of the pet door 10 in accordance with the present invention. The door 10 is dimensioned and configured to be inserted in a sliding glass door (not shown) and includes a frame 12 having respective openings first and second openings in which respective first and second movable clear pliable plastic, such as vinyl, door flaps 14, 16 are suspended from the respective openings in the frame 12. In the illustrated preferred embodiment the larger top flap 14 is preferably a clear, pliable flap that measures 12″×17½″ and the small flap 16 is also a clear pliable flap directly centered below the large flap 14. In the illustrated preferred embodiment the small flap 16 measures 7½″×8″. The respective pet doors including the flaps 14, 16 may be customized to allow specific access to intended use animals only. While the illustrated preferred embodiment has two pet doors, it will be understood that other embodiments may have more than two doors.

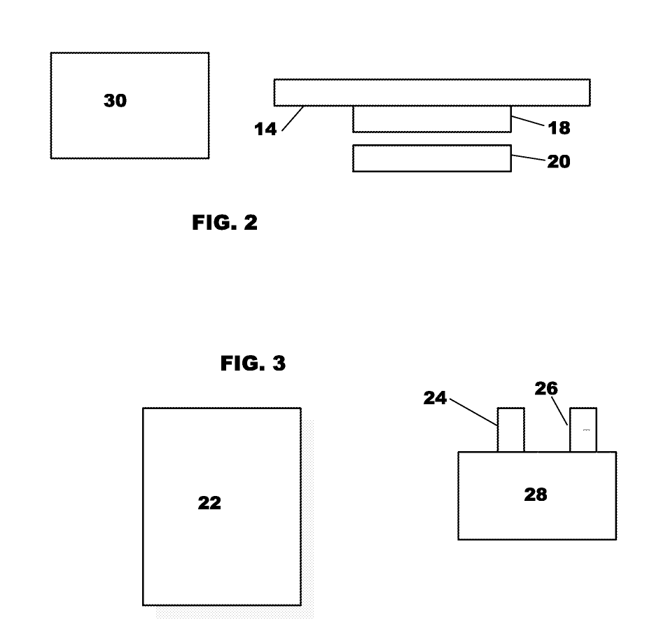

As best seen in FIG. 2 a permanent magnet 18 secures the flap 14 in seated relationship with respect to the frame 12. In at least some embodiments the frame 12 will be manufactured of aluminum. Because aluminum is a non-magnetic material, embodiments of the invention using an aluminum frame will utilize a ferromagnetic material pad 20 fixed to the frame 12 to achieve magnetic latching between the frame 12 and the flap 14. In embodiments of the present invention in which the frame is manufactured of a ferromagnetic material there will be no necessity to provide a separate ferromagnetic material pad 20. It will be understood that both the flap 14 and the flap 16 are magnetically latched in preferred embodiments of the present invention. This magnetic latching will be understood to allow a pet to easily move the flap at will while avoiding the movement of insects and conditioned air between the interior and exterior of the building. The diagrammatic representation of the magnetic latching should be understood to be representative of a plurality magnetic latches about the periphery of individual flaps 14, 16.

In preferred embodiments of the present invention, the apparatus includes a microcontroller 22 that is used to operate and control respective retractable stops 24, 26 disposed in a base 28 as shown diagrammatically in FIG. 3. The base 28 is represented by a rectangular block having a top surface which will be understood to be substantially flush with one of the flaps 14, 16. The retractable stops 24, 26 are shown in their extended positions. In these extended positions the stops 24, 26 will abut opposed sides of one of the flaps 14, 16. Thus, the extended stops 24, 26 will prevent movement of the flap in a manner that would not allow a pet to either exit a building or enter a building. Retraction of one of the stops will allow a pet to pass in one direction but not in both directions. Retraction of both the stops will allow a pet to pass in either direction. Typically, the stops 24, 26 will be solenoid controlled.

In preferred embodiments of the present invention retractable stops 24, 26 are disposed at the bottom of each of the flaps 14, 16. Ordinarily a single microcontroller 22 is sufficient to operate a set of retractable stops 24, 26 cooperating with the flap 14 as well as a set of retractable stops 24, 26 cooperating with the flap 16. Because the microcontroller 22 is programmable the user of the apparatus is able to individually program access to each of the openings defined by the flaps 14, 16. Thus, the owner is able to predetermine times and time intervals when a specific pet can go outside or can return to the interior of the building. Other embodiments of the present invention may use mark pinnacle counterparts to achieve that the route desired degree of control, however, microcontroller embodiments will in general be much more cost effective.

Some embodiments of the present invention may further include sensors to indicate when either flap 14, 16 is open. The sensors will be incorporated into each ferromagnetic material pad 20 in some embodiments to provide an alarm 30 responsive to these sensors. Such an alarm provides a warning of any or all flaps 14, 16 being “open”. More particularly, the alarm may be initiated if a flap remains open for a predetermined time. Thus, if a baby were to crawl through the openings, the apparatus in accordance with the present invention will provide a warning of impending danger. The microcontroller 22 will also control this function in preferred embodiments of the present invention.

A microcontroller (also microcontroller unit, MCU or μC) is a small computer on a single integrated circuit consisting of a relatively simple CPU combined with support functions such as a crystal oscillator, timers, watchdog timer, serial and analog I/O etc. Program memory in the form of NOR flash or OTP ROM is also often included on chip, as well as a typically small amount of RAM. Microcontrollers are designed for small or dedicated applications. Thus, in contrast to the microprocessors used in personal computers and other high-performance or general purpose applications, simplicity is emphasized. Some microcontrollers may operate at clock rate frequencies as low as 4 kHz, as this is adequate for many typical applications, enabling low power consumption (milliwatts or microwatts). They will generally have the ability to retain functionality while waiting for an event such as a button press or other interrupt; power consumption while sleeping (CPU clock and most peripherals off) may be just nanowatts, making many of them well suited for long lasting battery applications. Other microcontrollers may serve performance-critical roles, where they may need to act more like a digital signal processor (DSP), with higher clock speeds and power consumption.

Microcontrollers are used in automatically controlled products and devices, such as automobile engine control systems, remote controls, office machines, appliances, power tools, and toys. By reducing the size and cost compared to a design that uses a separate microprocessor, memory, and input/output devices, microcontrollers make it economical to digitally control even more devices and processes. Mixed signal microcontrollers are common, integrating analog components needed to control non-digital electronic systems.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A pet access door apparatus for an associated building which comprises:
a frame;
a first opening defined by said frame having a first size; and
a second opening defined by said frame having a second size that is different from said first size.

2. The apparatus as described in claim 1 wherein:
each of said openings has a flap disposed therein, each a flap having an edge, said edge engaging said frame whereby said flap is suspended from said edge.

3. The apparatus as described in claim 2 wherein:
each flap include peripheral magnetic material at peripheral portions thereof remote from said edge whereby said flap is releasably magnetically latched to said frame when said flap is suspended from said frame at said edge.

4. The apparatus as described in claim 3 wherein said frame is aluminum and said flap is magnetically latched by means of a ferromagnetic pad.

5. The apparatus as described in claim 2 wherein each flap has first and second sides and said apparatus further includes a first retractable stop abutting a first side of at least one of said flaps.

6. The apparatus as described in claim 5 wherein said first retractable stop retracts to allow movement of said at least one of said flaps in a first direction.

7. The apparatus as described in claim 5 wherein said first retractable stop extends to prevent movement of said at least one of said flaps in a first direction.

8. The apparatus as described in claim 5 further including a second stop abutting a second side of said at least one of said flaps.

9. The apparatus as described in claim 8 wherein said second stop retracts to allow movement of said one of said flaps in a second direction.

10. The apparatus as described in claim 8 wherein said second stop extends to prevent movement of said one of said flaps in a second direction.

11. The apparatus as described in claim 5 further including a microcontroller and wherein said first stop is controlled by said microcontroller.

12. The apparatus as described in claim 8 further including a microcontroller and wherein said second stop is controlled by said microcontroller.

13. The apparatus as described in claim 2 further including an alarm if either flap remains opens for more than a predetermined time.

14. The apparatus as described in claim 11 wherein said apparatus is programmable to individually limit opening of said flap.

15. The apparatus as described in claim 14 wherein said apparatus is programmable with respect to the time and duration of retraction and extension of said stop.

16. A pet access door apparatus for an associated building which comprises:
a frame;
a first opening defined by said frame having a first size;
a second opening defined by said frame having a second size that is different from said first size;
said openings each having a flap disposed therein, each a flap having an edge, said edge engaging said frame whereby said flap is suspended from said edge;
each flap has first and second sides;
said apparatus further includes discrete first retractable stops abutting a first side of each of said flaps, each first retractable stop retracts to allow movement of the abutting flap in a first direction and extends to prevent movement of the abutting flap in said first direction; and
said apparatus further includes discrete second stops abutting a second side of each of said flaps, each second stops retracting up to allow movement of said abutting flap in a second direction and extends to prevent movement of said abutting flap in said second direction;
said apparatus further includes a microcontroller and each of said first stop and said second stops are controlled by a microcontroller.

17. The apparatus as described in claim 16 wherein
said apparatus is programmable to individually limit opening of each of said flaps.

18. The apparatus as described in claim 17 wherein said apparatus is programmable with respect to the time and duration of retraction and extension of each stop.
